(19) United States
(12) Patent Application Publication
(10) Pub. No.: US 2012/0319957 A1
(43) Pub. Date: Dec. 20, 2012

(54) TRANSACTION TERMINAL COMPRISING A VIEW SHIELD

(75) Inventors: Annika Birkler, Malmo (SE); Hanna Helgesson, Malmo (SE); Bengt I. Larsson, Malmo (SE); Kevin Burnett, Austin, TX (US); Paul De La Port, Austin, TX (US); Scott Negley, Austin, TX (US); Neil Thomas, Austin, TX (US)

(73) Assignee: Dresser Wayne AB, Malmo (SE)

(21) Appl. No.: 13/502,254

(22) PCT Filed: Oct. 16, 2009
(86) PCT No.: PCT/EP09/63620

§ 371 Date: Sep. 6, 2012

(51) Int. Cl. G06F 3/02

(52) U.S. Cl. 345/168

(57) ABSTRACT

A transaction terminal is provided. The transaction terminal comprises a display configured to present information to a user of the terminal, a keypad which is separate from the display and configured to receive input from the user, and a view shield. The view shield is arranged to prevent a view of at least a part of the keypad in a first direction, and allow a view through the view shield of at least a part of the display in a second direction, wherein the second direction is different from the first direction.

### CROSS REFERENCE TO RELATED APPLICATIONS

This is a national stage application under 35 U.S.C. §371(c) of prior-filed, co-pending PCT patent application serial number PCT/EP2009/063620, filed on Oct. 16, 2009, the entire contents of which are incorporated herein by reference.

### BACKGROUND OF THE INVENTION

Embodiments of the present invention generally relate to a transaction terminal and, more specifically, to a transaction terminal comprising a view shield.

Theft of passwords, pass codes and PIN-codes for credit cards and charge cards etc. at transactions terminals such as ATMs, cash dispensers or payment terminals at train stations, airports, ticket machines or petrol stations (i.e. petrol pumps) is a widespread problem. For example, a fraudulent party may steal the code by secretly looking over the shoulder of an unsuspecting user of the terminal. A more elaborate way of stealing the code is to mount a camera at the transaction terminal and record what keys of the keypad the user presses. Typically in such a situation, the camera is mounted above the keypad.

In the prior art, there exists a number of solutions for preventing such theft of codes. For example, plates may be provided on the sides of the keypad. Although this makes it more difficult for a thief to catch a glimpse of the keypad it does not protect against cameras mounted above the keypad.

In the prior art, protection against cameras has been provided by arranging a plate above the keypad. However, such a cover makes it difficult for the user to see the keypad and thus makes it difficult for the user to enter the correct code. Moreover, the underside of such a cover may be an ideal camera location since it will be very difficult for the user of the terminal to spot the camera from above.

Thus there is a need for better protection against theft of codes at transactions terminal.

### BRIEF SUMMARY OF THE INVENTION

According to an embodiment of the present invention, there is provided a transaction terminal. The transaction terminal comprises a display configured to present information to a user of the terminal, a keypad which is separate from the display and configured to receive input from the user, and a view shield. The view shield is arranged to prevent a view of at least a part of the keypad in a first direction, and allow a view through the view shield of at least a part of the display in a second direction, wherein the second direction is different from the first direction.

### BRIEF DESCRIPTION OF THE DRAWINGS

The above, as well as additional objects, features and advantages of the present invention, will be better understood through the following illustrative and non-limiting detailed description of the present invention, with reference to the appended drawings, where like reference numerals will be used for like elements, wherein:

FIG. 1 illustrates a transaction terminal in accordance with an embodiment of the present invention;

FIG. 2 is a schematic side view of a transaction terminal and a user of the transaction terminal in accordance with an embodiment of the present invention;

FIGS. 3a-c illustrate a view shield in accordance with an embodiment of the present invention;

FIGS. 4a-c illustrate a view shield in accordance with an embodiment of the present invention;

FIG. 5 illustrates a view shield in accordance with an embodiment of the present invention;

FIG. 6 illustrates a view shield in accordance with an embodiment of the present invention;

FIG. 7 illustrates a view shield for use at a transaction terminal in accordance with an embodiment of the present invention; and

FIG. 8 illustrates a view shield for use at a transaction terminal in accordance with an embodiment of the present invention.

### DETAILED DESCRIPTION OF THE EXEMPLARY EMBODIMENTS OF THE INVENTION

In view of the above, embodiments of the present invention provide an improved protection against code theft at a transaction terminal.

FIG. 1 illustrates a transaction terminal 1 of an embodiment in accordance with the present invention. The transaction terminal 1 may be a transaction machine such as an ATM, a cash dispenser or a payment terminal, a ticket machine or the like at e.g. a train station or an airport. Especially, the transaction terminal 1 may be a payment terminal at a petrol pump at a petrol station.

The transaction terminal 1 comprises a display 2 for presenting information to a user of the terminal 1. The display 2 may prompt the user to supply information such as an amount to withdraw from an account, a destination for a trip, which fuel pump to use etc., wherein the specific type of information depends on the use and the type of transaction terminal. Especially, the display 2 may prompt the user to enter sensitive information such as a password, a pass code or a PIN-code for confirming e.g. a withdrawal or a transaction.

The transaction terminal 1 comprises a keypad 3. The user may input information to the transaction terminal 1 by pressing the keys of the keypad 3. Especially, when prompted by information on the display 2 the user may enter the sensitive information using the keypad 3.

A fraudulent party may attempt to steal information input by the user on the keypad 3. By way of example, a fraudulent party may attempt to steal the information by looking over the shoulder of the user and noting what keys of the keypad 3 the user pushes. According to a more elaborate method, a fraudulent party may mount a camera at the transaction terminal 1 and attempt to record the key presses of the user.

The transaction terminal 1 comprises a view shield 4. The view shield 4 is mounted at a level above the upper edge of the display 2. In FIG. 1, the view shield 4 is arranged in a substantially horizontal plane. However, optionally the view shield 4 may be arranged at an angle with the horizontal plane. Seen from the side, the view shield 4 may present a straight or curved profile. In any case, the view shield 4 may make it more difficult to steal information entered on the keypad 3. The purpose and function of the view shield 4 will be described in detail below.

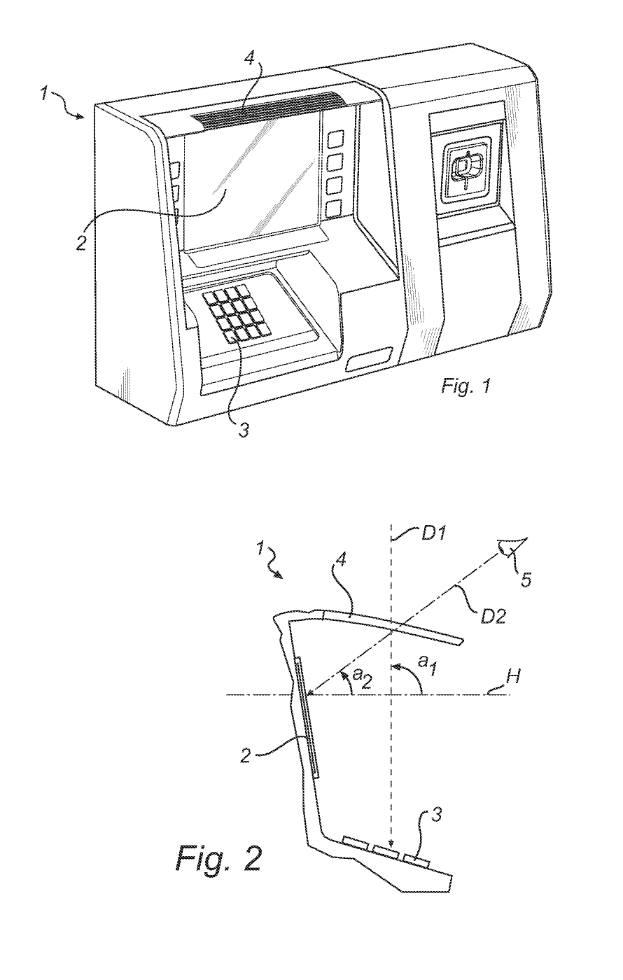

FIG. 2 is a schematic side view of the transaction terminal 1 and a user 5 interacting with the transaction terminal 1. As seen in FIG. 2, the view shield 4 extends in front of the keypad 3 as viewed in a direction D1. Moreover, the view shield 4 extends in front of an upper part of the display 2 as viewed in a direction D2. Preferably, the view shield 4 does not extend in front of the keypad 3 as viewed by the user 5. Thus, the view shield 4 is arranged to not prevent, i.e. allow, a view of the keypad 3 for the user 5. D1 presents a first angle a1 with respect to the horizontal plane H and D2 presents a second angle a2 with respect to the horizontal plane H, wherein a2 is smaller than a1. According to the first embodiment, D1 is a substantially vertical direction and D2 corresponds to a display viewing direction for the user 5 of the terminal 1. Hence, the view shield is arranged in the line of sight between the user 5 and the upper part of the display 2.

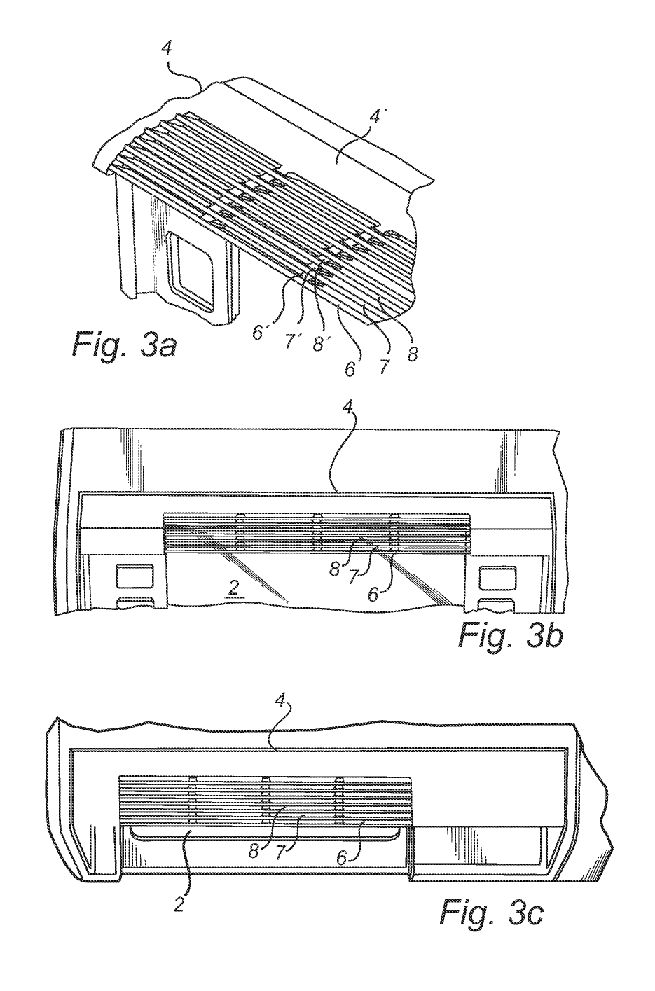

FIGS. 3a-c illustrate the view shield 4 of the first embodiment. The view shield 4 comprises a slab 4′ and a plurality of laths 6, 7, 8. The laths 6, 7, 8 are arranged in a cut-out of the slab 4′. The laths 6, 7, 8 are attached at their outer ends to the two opposite sides of the cut-out. The laths 6, 7, 8 may be attached e.g. by gluing or welding. Alternatively, the slab 4′ and the laths 6, 7, 8 may be integrally formed e.g. in a molding process.

The slab 4 and the laths 6, 7, 8 may be made of an opaque material such as plastic, metal, rubber or similar. Optionally, slab 4′ and the laths 6, 7, 8 may be made of a transparent material such as glass or plastic. The level of transparency of the material in the slab and/or the laths is selected so as to make viewing through the material difficult or impossible.

However it should be noted that this specific design of the view shield 4 only is given by way of example and that other designs also are possible within the scope of the present invention as defined by the appended claims. For example, the view shield 4 need not comprise the slab 4′. The laths 6, 7, 8 may instead be attached to, or integrally formed with, one or more bars which are attached at their inner ends to the transaction terminal 1 above the display 2, wherein the bars support the laths 6, 7, 8.

The laths 6, 7, 8 are spaced in a direction substantially perpendicular to the direction D2. The laths 6, 7, 8 are inclined such that their upper faces extend in parallel with the direction D2. The laths 6, 7, 8 overlap or at least touch each other when viewed in the direction D1. Optionally, the view shield 4 may comprise spacers 6′, 7′, 8′ attached between the laths 6, 7, 8 as illustrated in FIG. 3a. The spacers 6′, 7′, 8′ may for example be glued or welded to the laths 6, 7, 8 or integrally formed with the laths 6, 7, 8 and the slab 4′. The spacers 6′, 7′, 8′ may act as a supporting structure between the laths 6, 7, 8 and thereby make the view shield 4 more durable. The spacers 6′, 7′, 8′ may be made of the same material as the laths 6, 7, 8 and the slab 4′.

The spacing of the laths 6, 7, 8 allows the user 5 to view the upper part of the display 2 through the view shield 4, i.e. between the laths 6, 7, 8, in the direction D2 as illustrated in FIG. 3b. The overlap or touch of the laths 6, 7, 8 prevent a view of the keypad 3 in the direction D1 as illustrated in FIG. 3c.

The view shield 4 may be arranged to allow viewing of the display 2 through the view shield 4 in a range of directions and not just the single direction D2. This allows users of different heights to see through the view shield 4. It may also provide some tolerance for different user positions.

The angles a1, a2, the range of allowed viewing directions of the display 2, i.e. the tolerance of the view shield 2, as well as the range of blocked viewing directions of the keypad 3 may be adapted by using laths of different widths, depth and/or by varying the inclination, the spacing and/or overlap of the laths 6, 7, 8.

In case a fraudulent party would mount a camera above the view shield 4, the camera could not be able to record the key presses of the user 5 since the view shield 4 blocks the view of the keypad 3 in the direction D1. The fraudulent party could attempt to circumvent this by mounting the camera on the underside of the view shield 4. However, in that case the camera would be easily spotted by the user 5 since the camera would be provided in the line of sight between the user 5 and the display 2.

The view shield 4 may also block outside light and thereby shade at least a part of the display 2.

The length of the laths 6, 7, 8 may be substantially equal to or larger than the width of the display 2 in order to provide an effective shading of the display 2 and allow a view of the full width of the display 2 through the view shield 4. Moreover, the length of the laths 6, 7, 8 may be sufficiently large for preventing a camera not mounted directly above the keypad 3 from viewing the keypad 3 from a side, past the view shield 4. The slab 4′ may also prevent this.

Optionally, as mentioned above, the view shield 4 may be provided with a curved profile as illustrated in FIGS. 3a-c. In FIGS. 3a-c only an outer section of the view shield 4 is bent downwardly. However, optionally the entire view shield 4 may be present a curved profile. By providing the view shield 4 with a curved profile, a more effective blocking of the keypad 3 and shading of a larger part of the display 2 may be achieved without substantially increasing the horizontal extension of the view shield 4, i.e. the depth of the view shield 4.

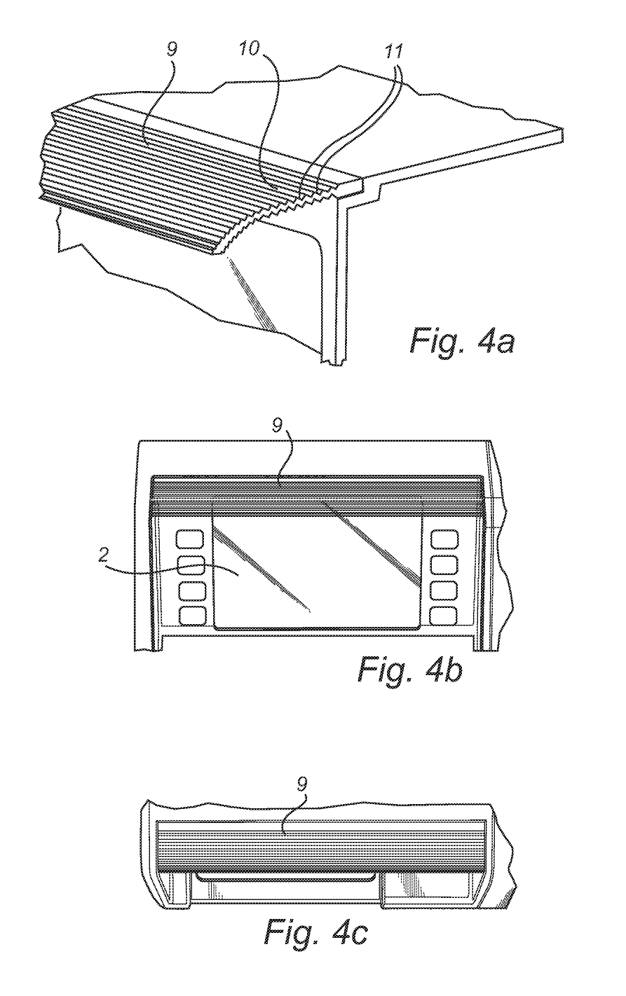

FIGS. 4a-c illustrate another view shield 9 of an embodiment which may be used at the transaction terminal 1. The view shield 9 has a stepped design and comprises a first plurality of surfaces 10 and a second plurality of surfaces 11. The surfaces of the first and second plurality of surfaces 10, 11 are arranged alternately and present a zigzag line when viewed sideways. Optionally, the view shield 9 may present a curved profile.

The first plurality of surfaces 10 are arranged to face the user and are transparent to such an extent as to allow a view of the display 2 in the direction D2. This is illustrated in FIG. 4b wherein the upper part of the display 2 is at least partly visible through the view shield 9.

The second plurality of surfaces 11 are facing opposite to the direction D1. The second plurality of surfaces 11 have such a low transparency as to prevent a view of the keypad 3 in the direction D1 through the second plurality of surfaces 11. For example, the second plurality of surfaces 11 may be provided with a frosted appearance to make see-through more difficult. According to a further example, the second plurality of surfaces 11 may be provided with an opaque surface, e.g. by arranging an opaque film on the second plurality of surfaces 11, thereby preventing a view of the keypad 3 in the direction D1. This is illustrated in FIG. 4c, which is a view in the direction D1, wherein a view of the keypad 3 is blocked by the view shield 9.

The stepped design and the alternating surfaces of the view shield 9 may be achieved by selectively blasting a transparent glass plate or a transparent plastic plate at an angle. Alternatively, the stepped design may be obtained by molding glass or plastics into the desired shape. A frosted appearance may be obtained by blasting the second plurality of surfaces 11. However, these ways of forming the view shield 9 are only provided by way of example and a view shield may be formed with other techniques well-known in the art without departing from the scope of the appended claims.

As illustrated in FIG. 4a both the upper and the lower face of the view shield present a zigzag line when viewed sideways. However, it is possible to block the view in the direction D1 by arranging only one side or face of the view shield with a stepped design. More specifically, depending on the angle of the direction D1 relative the plane of the first plurality of surfaces 10 of the stepped design, the view shield 9 will block the view in the direction D1 even though the other face, e.g. the lower face, of the view shield 9 is smooth. The angular range in which view through the view shield 9 is blocked may be adjusted by altering the angles between the first and the second plurality of surfaces 10, 11.

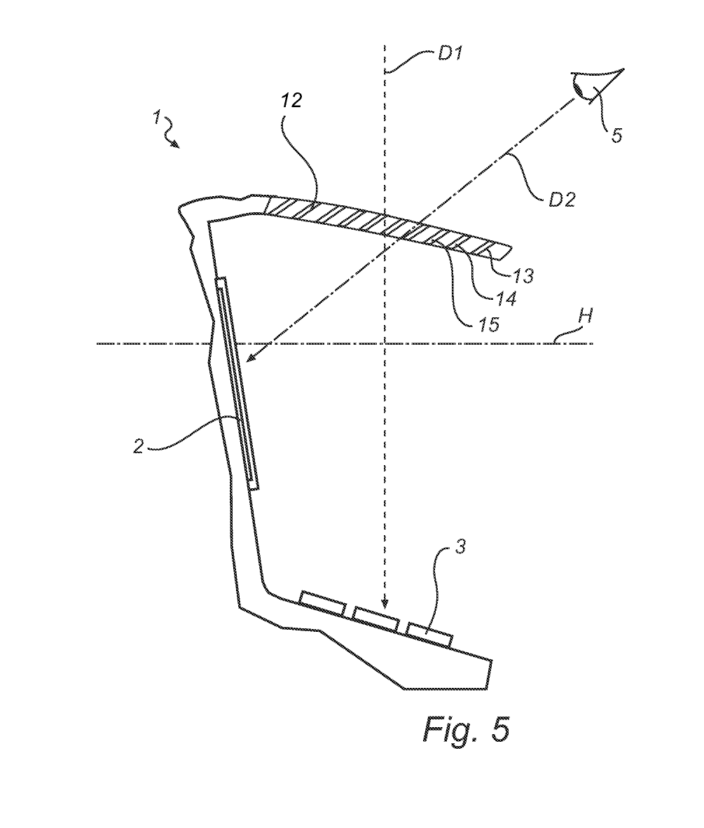

FIG. 5 illustrates a view shield 12 of a third embodiment which may be used instead of the view shield 4 or 9 at the transaction terminal 1 of the first embodiment. The view shield 12 comprises a transparent plate e.g. made of glass or plastics. Optionally, the transparent plate may present a curved profile. The transparent plate comprises a plurality of laths 13, 14, 15 which are integrated with the transparent plate. The laths 13, 14, 15 present a transparency which is lower than the transparency of the transparent plate. For example, the laths 13, 14, 15 may be made of an opaque material such as plastic, metal, rubber or similar. Alternatively, instead of laths 13, 14, 15, thin elongated sheets or layers with a low or zero transparency may be integrated in the transparent plate.

The laths 13, 14, 15 are spaced in a direction substantially perpendicular to the direction D1. The laths 13, 14, 15 are inclined such that their upper faces extend in parallel to the direction D2. The laths 13, 14, 15 overlap or at least touch each other as seen in the direction D1. The spacing of the laths 13, 14, 15 allows the user 5 to view the upper part of the display 2 through the view shield 4 in the direction D2. The overlap or touch between the laths 13, 14, 15 prevent a view of the keypad 3 in direction D1.

According to an embodiment, the view shield 12 may comprise a transparent plate without any laths. According to this embodiment, the transparency of the plate is chosen as to enable viewing of a luminous display through the material while a less illuminated keypad will be difficult or impossible to view.

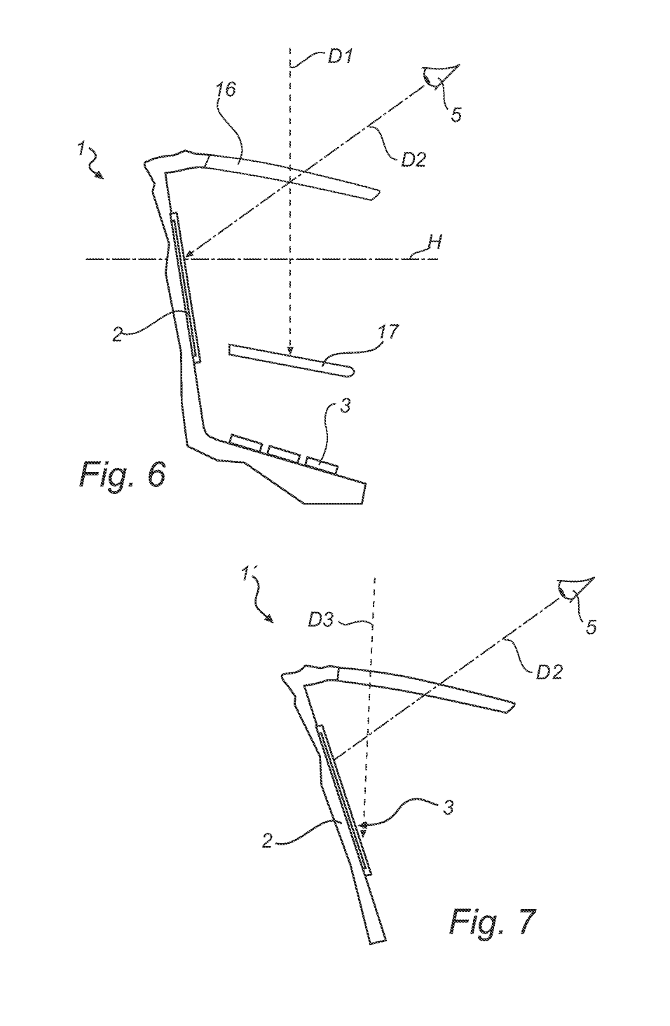

FIG. 6 illustrates another view shield of an embodiment which may be used at the transaction terminal 1. In accordance with the embodiment, the view shield comprises a first polarizer 16 and a second polarizer 17. The first polarizer 16 is provided above the display 2. The second polarizer 17 is provided below the display 2 and above the keypad 3. The first and the second polarizer 16 and 17 may be linear polarizers. The first and the second polarizer 16 and 17 may be arranged in parallel to each other. However a non-parallel arrangement is also possible.

The first and second polarizer 16 and 17 are arranged to prevent a view of the keypad 3 in the direction D1. More specifically, the first and the second polarizer 16 and 17 are preferably arranged to face the direction D1. Moreover, the second polarizer 17 is preferably arranged such that its axis is substantially orthogonal to the axis of the first polarizer 16.

Optionally, a non-orthogonal arrangement of the axes of the first and second polarizer 16, 17 may also be used as long as the total transmission of light through the second and first polarizer 16, 17 in the direction opposite to D1 is sufficiently low for preventing a view of the keypad 3.

In any case, the second polarizer 17 will polarize the light (generated and transmitted or incoming and reflected) from the keypad 3 in the direction of the axis of the second polarizer 17. The portion of this polarized light which reaches the first polarizer 16 will hence be blocked (completely or partly) or redirected such that a view of the keypad 3 in the direction D1 is prevented.

However, the view shield still allows the user 5 to view the display through the first polarizer 16 and the keypad 3 through the second polarizer 17. In case the display comprises a polarized layer (which is common in may LCD displays) the axis of the first polarizer 16 is arranged such that a view in the direction D2 from a user to the display is not impeded.

In case a fraudulent party would mount a camera above the view shield, i.e. above the first polarizer 16, the camera would not be able to record the key presses of the user 5 since the combination of the first and the second polarizer 16, 17 blocks the view of the keypad 3 in direction D1. The fraudulent party could attempt to circumvent the view shield by mounting the camera on the underside of the first polarizer 16. However, in that case the user 5 would easily spot the camera since it would be arranged in the line of sight between the user 5 and the display 2. Alternatively, the fraudulent party could attempt to circumvent the view shield by mounting the camera on the underside of the second polarizer 17. However, in that case the user 5 would still easily spot the camera since it would be arranged in the line of sight between the user 5 and the keypad 3.

According to an alternative design, instead of the first and the second polarizer 16, 17 the view shield may comprise a first and a second plate with a relatively low transparency. The transparency of the first plate is such that it allows a view of the display 2 through the first plate in the direction D2. Moreover, the transparency of the second plate is such that it allows a view of the keypad 3 through the second plate. However, the combined transparency of the first and the second plate is such that a view of the keypad 3 in the direction D1 is prevented. By way of example the transmittance of the first and the second plate may be about 10% within the visible spectrum which yields a combined transmittance of roughly 1%.

FIG. 7 illustrates an alternative transaction terminal 1′ wherein the display 2 is a touch display. The alternative transaction terminal 1′ is arranged to provide a graphic representation of a keypad 3 in the display 2. The user may input information to the transaction terminal 1′ by pressing the keys of the keypad 3 on the display 2. The alternative transaction terminal 1′ may be provided with a view shield of any of the first, second or third embodiment 4, 9 or 12. In the alternative transaction terminal 1′, a view shield 4, 9, or 12 is arranged to prevent a view of at least a part of the display 2 in the direction D3 and allow a view of at least this part of the display 2 through the view shield 4, 9 or 12. Preferably, the keypad 3 is displayed on this part of the display 2.

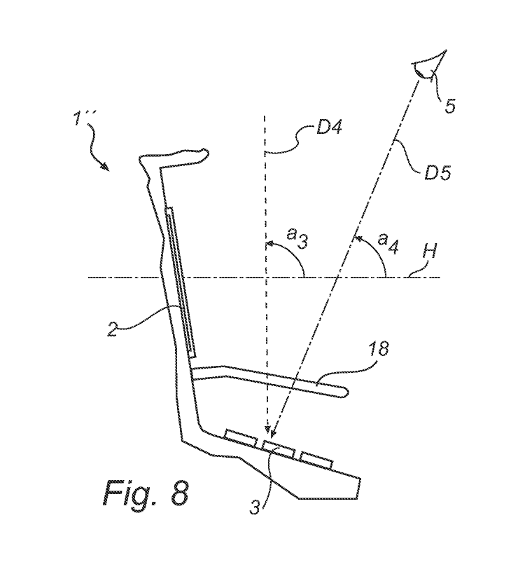

FIG. 8, illustrates yet another alternative transaction terminal 1″. This alternative transaction terminal 1″ is similar to the transaction terminal 1 however no view shield is provided above the display 2. Instead, there is provided a view shield 18 below the display 2 but above the keypad 3. The view shield 18 may be of a type in accordance with the view shields of any of the first, second or third embodiments 4, 9 or 12 however in this case the view shield 18 is arranged to prevent a view at least a part of the keypad in a direction D4, and arranged to allow a view of the keypad through the view shield 18 in a direction D5. The direction D4 presents an angle a3 with respect to a horizontal plane H and the direction D5 presents an angle a4 with respect to the horizontal plane H. The angle a3 is larger than the angle a4.

In case a fraudulent party would mount a camera above the view shield 18, the camera would not be able to record the key presses of the user 5 since the view shield 18 blocks the view of the keypad 3 in the direction D4. The fraudulent party could attempt to circumvent this by mounting the camera on the underside of the view shield 18. However, in that case the camera would be easily spotted by the user 5 since the camera would be provided in the line of sight between the user 5 and the keypad 3, i.e. in the direction D5.

According to an embodiment of the present invention, there is provided a transaction terminal. The transaction terminal comprises a display arranged to present information to a user of the terminal, a keypad which is separate from the display and arranged to receive input from the user and a view shield. The view shield is arranged to prevent a view of at least a part of the keypad in a first direction, and allow a view through the view shield of at least a part of the display in a second direction, wherein the second direction is different from the first direction.

According to an embodiment, the transaction terminal may be any one of an ATM, a cash dispenser, and a payment terminal. Especially, the transaction terminal may be a payment terminal at a petrol pump at a petrol station.

The view shield of the transaction terminal according to an embodiment of the present invention prevents a view of the keypad in a first direction but allows a view through the view shield of the display in a second direction. The view shield thus prevents a fraudulent party from viewing the keypad by looking over the shoulder of the user or by mounting a camera at the transaction terminal.

According to an embodiment, the view shield is arranged at a level above the display. The view shield may thus provide shading of at least a part of the display. A fraudulent party could be tempted to mount a camera on the view shield. However, in that case the camera would be easily spotted by the user through the view shield in the second direction.

Especially, in case the keypad is arranged at a level below the display the view shield may prevent a view of the keypad in a downwardly looking direction.

According to an embodiment, the view shield presents a first distance to the display at an inner part of the view shield and a second distance to the display at an outer part of the view shield, i.e. the view shield slopes downwards from the inner part of the view shield to the outer part.

According to an embodiment, the view shield comprises a first plurality of surfaces preventing a view of the keypad in the first direction.

According to an embodiment, the view shield comprises a second plurality of surfaces allowing a view of at least a part of the display in the second direction.

According to an embodiment, the surfaces of the first plurality of surfaces and the surfaces of the second plurality of surfaces are arranged alternately.

According to an embodiment, the first plurality of surfaces is surfaces of a plurality of spaced elongated members. The elongated members may be thin elongated plates. Especially, the elongated members may be laths. The laths may thus block a view of the keypad in the first direction and allow a view of the display between the spaced laths. The laths may be spaced as to allow a view through the view shield of at least a part of the display in a second direction. Moreover, the laths may be overlapping when viewed in the first direction.

According to an embodiment, the elongated members are integrated into a transparent plate.

According to an embodiment, the first direction presents a first angle with respect to a horizontal plane and the second direction presents a second angle with respect to the horizontal plane, wherein the first angle is larger than the second angle. The second direction may be a direction for proper viewing of a display for the user of the transaction terminal. I.e. the second direction may be a display viewing direction for the user of the transaction terminal.

According to an embodiment, the view shield is arranged to allow a view of the keypad for the user of the transaction terminal.

In the above, the present invention has mainly been described with reference to a few embodiments. However, as is readily appreciated by a person skilled in the art, other embodiments than the ones disclosed above are equally possible within the scope of the present invention, as defined by the appended claims

What is claimed is:

1. A transaction terminal comprising:
a display configured to present information to a user of the terminal;
a keypad which is separate from the display and configured to receive input from the user; and
a view shield arranged to prevent a view of at least a part of the keypad in a first direction, and allow a view through the view shield of at least a part of the display in a second direction, wherein the second direction is different from the first direction.

2. The transaction terminal as claimed in claim 1, wherein the view shield is arranged at a level above the display.

3. The transaction terminal as claimed in claim 2, wherein the view shield presents a first distance to the display at an inner part of the view shield and a second distance to the display at an outer part of the view shield.

4. The transaction terminal as claimed in claim 1, wherein the keypad is arranged at a level below the display.

5. The transaction terminal as claimed in claim 1, wherein the view shield comprises a lust plurality of surfaces preventing at least a part of a view of the keypad in the first direction.

6. The transaction terminal as claimed in claim 5, wherein the view shield comprises a second plurality of surfaces allowing a view of at least a part of the display in the second direction.

7. The transaction terminal as claimed in claim 6, wherein the surfaces of the first plurality of surfaces and the surfaces of the second plurality of surfaces are arranged alternately.

8. The transaction terminal as claimed in claim 5, wherein the first plurality of surfaces is surfaces of a plurality of spaced laths.

9. The transaction terminal as claimed in claim 8, wherein the laths are spaced as to allow a view through the view shield of at least a part of the display in a second direction.

10. The transaction terminal as claimed in claim 8, wherein the laths are overlapping when viewed in the first direction.

11. The transaction terminal as claimed in claim 7, wherein the laths are integrated into a transparent plate.

12. The transaction terminal as claimed in claim 1, wherein the first direction presents a first angle with respect to a horizontal plane and the second direction presents a second angle with respect to the horizontal plane, wherein the first angle is larger than the second angle.

13. The transaction terminal as claimed in claim 1, wherein the second direction is a direction for proper viewing of the display for the user of the transaction terminal.
